(19) United States
(12) Patent Application Publication
(10) Pub. No.: US 2025/0012614 A1
(43) Pub. Date: Jan. 9, 2025

(54) SENSOR ARRAY CONTINUOUS CAPACITIVE LEVEL SENSOR

(71) Applicant: SETRA SYSTEMS, INC., Boxborough, MA (US)

(72) Inventor: Nathan H. KULAK, Collinsville, CT (US)

(21) Appl. No.: 18/763,805

(22) Filed: Jul. 3, 2024

Related U.S. Application Data
(60) Provisional application No. 63/525,463, filed on Jul. 7, 2023.
(60) Provisional application No. 63/534,911, filed on Aug. 28, 2023.

(51) Int. Cl. G01F 23/263

(52) U.S. Cl. CPC G01F 23/263

(57) ABSTRACT

Systems, apparatuses, and methods provide for a fluid level sensor including a continuous sensor wire located within a tube, where the continuous sensor wire runs from an upper end of the tube to a lower end of the tube. A ground wire is located within the tube, where the ground wire runs from the upper end of the tube to the lower end of the tube. A wet reference wire is located within the tube, where the wet reference wire runs from the upper end of the tube to the lower end of the tube. A dry reference wire is located within the tube, wherein the dry reference wire is located adjacent the upper end of the tube.

### FIELD

The instant disclosure relates generally to systems, apparatuses, and methods for a fluid level sensing strip. In particular, embodiments of the instant disclosure relate to systems, apparatuses, and methods for a trimmable fluid level sensing strip.

### BACKGROUND

Capacitive based sensing is a common technical modality for the detection of liquids in tanks, pipes, bottles, and other vessels. These sensors come in both continuous and single point varieties, and are commonly assembled in tubular geometry, strips and probes.

No matter the variety, these sensors all require a sense and ground electrode (also referred to as conductors herein) insulated from direct contact with the measured media. When the insulated electrodes are placed in the presence of media a corresponding change in capacitance results. This change is interpreted as a change in level and/or presence of liquid. However, these prior art sensors require compensation and calibration which is inconvenient and time-consuming.

### SUMMARY

Embodiments of the present invention provide an improved capacitive sensor comprising a sensor array with a number of conductors that provide numerous benefits over the prior art.

As will be described in greater detail below, in some implementations discussed herein, systems, apparatuses, and methods provide for a fluid level sensor including a continuous sensor wire located within a tube, where the continuous sensor wire runs from an upper end of the tube to a lower end of the tube. A ground wire is located within the tube, where the ground wire runs from the upper end of the tube to the lower end of the tube. A wet reference wire is located within the tube, where the wet reference wire runs from the upper end of the tube to the lower end of the tube. A dry reference wire is located within the tube, wherein the dry reference wire is located adjacent the upper end of the tube.

In one example, a fluid level sensor includes a substrate and a continuous sensor plate located on the substrate, where the continuous sensor plate runs from an upper end of the substrate to a lower end of the substrate. A continuous ground plate is located on the substrate, where the continuous ground plate runs from the upper end of the substrate to the lower end of the substrate. A wet reference capacitive plate is located on the substrate, where the wet reference capacitive plate is located adjacent the lower end of the substrate. A dry reference capacitive plate is located on the substrate, where the dry reference capacitive plate is located adjacent the upper end of the substrate.

In another example, operations of a fluid level sensor includes sensing a fluid capacitance level via a continuous sensor wire located within a tube, where the continuous sensor wire runs from an upper end of the tube to a lower end of the tube. A wet reference capacitance value is determined via a wet reference wire located within the tube, where the wet reference wire runs from the upper end of the tube to the lower end of the tube. A dry reference capacitance value is determined via a dry reference wire located within the tube, wherein the dry reference wire is located adjacent the upper end of the tube. An output fluid level is determined based on the sensed fluid capacitance level, the wet reference capacitance value, and the dry reference capacitance value.

In a further example, operations of a fluid level sensor includes sensing a fluid level via a continuous sensor plate of a fluid level sensor, where the sensor plate runs from an upper end of a substrate to a lower end of the substrate. A wet reference value is determined via a wet reference capacitive plate located adjacent the lower end of the substrate. A dry reference value is determined via a dry reference capacitive plate located adjacent the upper end of the substrate. An output fluid level is determined based on the sensed fluid level, the wet reference value, and the dry reference value. A trace is shielded from capacitive interference via a wet reference shield, where the trace and the wet reference shield run from the upper end of the substrate to the wet reference capacitive plate.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates a front view of a fluid level sensor according to an example of the instant disclosure;

FIG. 2 illustrates a front view of another fluid level sensor according to an example of the instant disclosure;

FIG. 3 illustrates a cross sectional side view of the fluid level sensor of FIG. 2 according to an example of the instant disclosure;

FIG. 4 illustrates a schematic view of a data processor according to an example of the instant disclosure;

FIG. 5 is an illustration of a flowchart of an example method for fluid level sensing according to an example of the instant disclosure;

FIG. 6 is a chart illustrating a simulation explaining the operation of embodiments of the present invention according to an example of the instant disclosure;

FIG. 7 is a block diagram illustrating a computer program product according to an example of the instant disclosure;

FIG. 8 is a block diagram illustrating an example fluid delivery apparatus according to an example of the instant disclosure; and

FIG. 9 is a block diagram illustrating a hardware apparatus including a semiconductor package according to an example of the instant disclosure.

### DETAILED DESCRIPTION OF THE PRESENT EMBODIMENTS

Some embodiments of the present invention comprise a sensor housing (e.g., a tube). The sensor housing may be a tube made of metal, plastic, or any other suitable material sealed from media ingress and containing suitable mounting to container ingress points. Within the tubing is the sensor array responsible for sensing the changing liquid media level as it surrounds the tube housing. The sensor array may comprise a wire bundle, a circuit board, a combination of the two, or any other suitable construction.

In some embodiments, the sensor array comprises a sense conductor (referred to herein as CL or C-LEVEL). CL is a non-shielded conductor (stranded or single strand) that runs the entire length of the sensor length and is responsible for reporting continuous change in capacitance with changing media level.

In some embodiments, the sensor array comprises an environmental reference conductor (referred to herein as RE). RE is a shielded conductor that runs only a small portion of the top of the sensor array where the shield is removed exposing the conductor and is responsible for compensating changes to the sensor environment e.g., surrounding air temperature etc.

In some embodiments, the sensor array comprises a liquid reference conductor (referred to herein as RL). RL is a shielded conductor that runs a length of the sensor equal to CL, the shielding is removed only at the very bottom of the run exposing the conductor. RL is responsible for changes in the dielectric of the media. In this manner, for example, two identical sensors submerged in two different media types would show the same output for a mutual level because differences in dielectric constant (or relative permittivity) are accounted for by virtue of values measured by RL. Or, as another example, one sensor in a media would not report significant level change due to changing temperature of the media.

In some embodiments, the sensor array comprises a ground conductor (referred to herein as GND). In plastic tubes, GND is an unshielded conductor that runs a length of the sensor equal to CL and acts as the ground. In metal tubes, GND may be bonded to the housing and the housing acts as the ground.

In some embodiments, some, or all the previously described sensors (including associated shields) may be printed onto a suitable ridged substrate. The responsibility of each sensor remains the same as in previously described embodiments, the printed construction may provide more stable and convenient construction by leveraging a multi-layer printed circuit board (PCB).

In some embodiments, some, or all the previously described sensors (including associated shields) may be printed onto a suitable flexible substrate. The responsibility of each sensor remains the same as in previously described embodiments. The printed flexible construction enables complete non-contact sensing through application of a suitable adhesive necessary to join the flexible embodiment to the exterior of the vessel of interest. In this embodiment an additional shield layer is utilized on top of the non-sensing side of the flexible construction to provide immunity to erroneous signals originating from outside the vessel of interest.

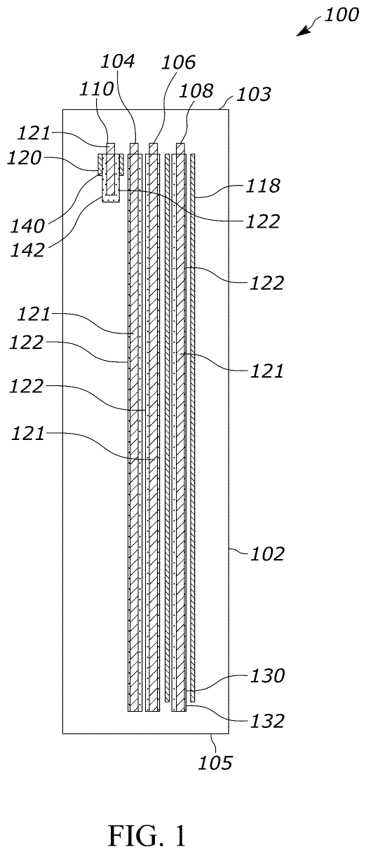

FIG. 1 depicts a fluid level sensor 100 embodiment of the present invention using a wire bundle, with a dry reference wire 110 (RE), a continuous sensor wire 104 (CL), a ground wire (GND) and a wet reference wire 108 (RL) being shown left to right. The fluid level sensor 100 includes a number of conductors 121, shields 118, 120, and a number of wire jackets 122 to isolate the conductors 121 (e.g., so that they do not short).

In some implementations, the fluid level sensor 100 includes a continuous sensor wire 104 located within a tube 102, where the continuous sensor wire 104 runs from an upper end 103 of the tube 102 to a lower end 105 of the tube. A ground wire 106 is located within the tube 102, where the ground wire 106 runs from the upper end 103 of the tube to the lower end 105 of the tube. A wet reference wire 108 is located within the tube 102, where the wet reference wire 108 runs from the upper end 103 of the tube 102 to the lower end 105 of the tube 102. A dry reference wire 110 is located within the tube 102, wherein the dry reference wire 110 is located adjacent the upper end 103 of the tube 102. An exposed end 132 of the wet reference wire 108 in proximity to the lower end 105 of the tube 102 is configured, when the sensor 100 is deployed relative to a vessel, to be at a minimum level of liquid to be measured, i.e., such that the wet reference wire 108 is capable of sensing dielectric constant of any amount of liquid in the vessel. On the other hand, an exposed end 142 of the dry reference wire 110 is configured, when the sensor 100 is deployed, to be above a maximum level of the liquid to be measured, i.e., such that the dry reference wire 110 is capable of sensing any environmental changes regardless of the level of liquid in the vessel.

In some examples, the fluid level sensor 100 further includes a wet reference shield sheath 118 located on a first covered portion 130 of the wet reference wire 108 so as to leave a second exposed portion 132 of the wet reference wire 108 uncovered from the wet reference shield sheath 118. Where present, the wet reference shield sheath 118, which may comprise a suitable electrically conductive material, shields the wet reference wire 108 from external interference, e.g., any changes to its capacitance due to the presence of the liquid being measured or other external factors that may affect the measured capacitance. In such an example, the second exposed portion 132 of the wet reference wire 108 is adjacent the lower end 105 of the tube 102 such that only the presence of liquid proximate the second exposed portion 132 has any effect on capacitance of the wet reference wire 108. In some implementations, the wet reference shield sheath 118 is electrically driven. For example, the wet reference shield sheath 118 may be driven by the same electrical signal used to measure capacitance of the continuous sensor wire 104.

In some implementations, the fluid level sensor 100 further includes a dry reference shield sheath 120, substantially similar to the wet reference shield sheath 118, located on a first covered portion 140 of the dry reference wire 110 so as to leave a second exposed portion 142 of the dry reference wire 110 uncovered from the dry reference shield sheath 120. In some examples, the dry reference shield sheath 120 is electrically driven in the same manner as the wet reference shield sheath 118.

In some examples, the continuous sensor wire 104, the ground wire 106, the wet reference wire 108, and the dry reference wire 110 are all flexible. In some implementations, the fluid level sensor 100 is flexed to conform to contours of a vessel being measured and/or to the contours of the tube 102. In some examples, the continuous sensor wire 104, the ground wire 106, the wet reference wire 108, and the dry reference wire 110 are composed or copper, another flexible conductive substance, and/or combinations thereof.

In operation, the fluid level sensor 100 senses a fluid capacitance level via capacitance of the continuous sensor wire 104. A wet reference capacitance value is determined via the wet reference wire 108 and a dry reference capacitance value is determined via the dry reference wire 110. An output fluid level is determined based on the sensed fluid capacitance level, the wet reference capacitance value, and the dry reference capacitance value. For example, the output fluid level may be determined by the following formula: Level=(CO−CL)/(RL−RE), where CO is a sensed fluid capacitance level when there is no fluid present, CL is the sensed fluid capacitance level, RL is the wet reference capacitance value, and RE is the dry reference capacitance value.

During operation, shielding may be performed via the wet reference shield sheath 118. In such an example, the wet reference shield sheath 118 is electrically driven. Additionally, or alternatively, during operation, shielding may be performed via a dry reference shield sheath 120. In such an example, the dry reference shield sheath 120 is electrically driven. Such shielding via the wet reference shield sheath 118 and/or the dry reference shield sheath 120 prevents interference between components of the fluid level sensor 100 and/or interference with a user (e.g., a user's hand).

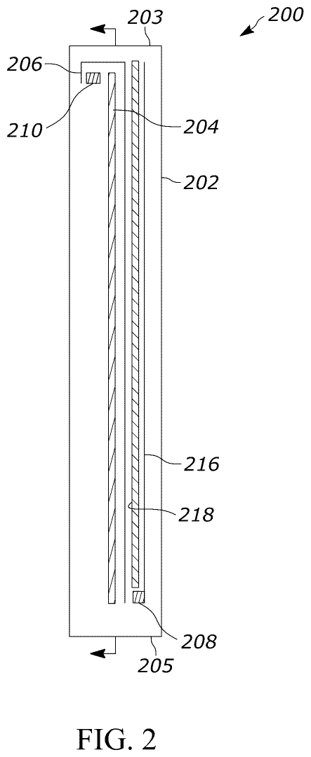

FIG. 2 depicts another fluid level sensor 200 embodiment of the present invention as it would be applied to a ridged or flexible substrate, with a continuous ground plate 206 (GND), a dry reference capacitive plate 210 (RE), a continuous sensor plate 204 (CL), shielding 218, and a wet reference capacitive plate 208 (RL) shown left to right (e.g., where, as depicted in FIG. 2, the continuous ground plate 206 (GND) hooks over top of the dry reference capacitive plate 210 (RE) and the continuous sensor plate 204 (CL)). For example, the continuous ground plate 206 (GND) is positioned relative to one sensor plate (e.g., the dry reference capacitive plate 210 (RE)) so that the continuous ground plate 206 (GND) does not impart significant stray capacitance on another sensor plate (e.g., the continuous sensor plate 204 (CL)). To achieve this, the continuous ground plate 206 (GND), which is unrelated to a given sensor plate (e.g., the continuous sensor plate 204 (CL)), is positioned in a spaced arrangement to the given sensor plate so as to limit the influence on the given sensor plate (e.g., the influence is reduced the further away the continuous ground plate 206 (GND) and the continuous sensor plate 204 (CL) are positioned away from one another). In the illustrated example, the continuous ground plate 206 (GND) hooks over top of the dry reference capacitive plate 210 (RE) the opposite side of the dry reference capacitive plate 210 (RE) away from the continuous sensor plate 204 (CL) to achieve that spaced arrangement distance between the continuous ground plate 206 (GND) and the continuous sensor plate 204 (CL).

As used herein, a “plate” refers to an electrically conductive material.

In some implementations, the fluid level sensor 200 includes a continuous sensor plate 204 located on a substrate 202, where the continuous sensor plate runs 204 from an upper end 203 of the substrate 202 to a lower end 205 of the substrate 202. A continuous ground plate 206 is located on the substrate 202, where the continuous ground plate 206 runs from the upper end 203 of the substrate 202 to the lower end 205 of the substrate 202. A wet reference capacitive plate 208 is located on the substrate 202, where the wet reference capacitive plate 208 is located adjacent the lower end 205 of the substrate 202. A dry reference capacitive plate 210 is located on the substrate 202, where the dry reference capacitive plate 210 is located adjacent the upper end 203 of the substrate 202.

As discussed above, in some examples, the substrate is flexible. For example, such a flexible substrate is composed of polyimide, polyamide, polyester, fluoropolymers, liquid crystal polymer, the like, and/or combinations thereof. In other examples, the substrate is rigid. For example, such a rigid substrate is composed of fiberglass, a reinforced epoxy resin, the like, and/or combinations thereof.

In some implementations the fluid level sensor 200 includes a trace 216 running from the upper end 203 of the substrate 202 to the wet reference capacitive plate 208 to electrically connect the wet reference capacitive plate 208 to measurement circuitry. In such an implementation, the fluid level sensor 200 may also include a wet reference shield 218 located adjacent the trace 216, where the wet reference shield 218 runs from the upper end 203 of the substrate 202 to the wet reference capacitive plate 208. In some examples, the wet reference shield 218 is electrically driven.

In some examples, a tube (e.g., as is illustrated in FIG. 1) is located around the fluid level sensor 200.

In operation, the fluid level sensor 200 senses a fluid capacitance level via capacitance of the continuous sensor plate 204. A wet reference capacitance value is determined via the wet reference capacitive plate 208 and a dry reference capacitance value is determined via the dry reference capacitive plate 210. An output fluid level is determined based on the sensed fluid capacitance level, the wet reference capacitance value, and the dry reference capacitance value.

For example, the output fluid level may be determined by the following formula: Level=(CO−CL)/(RL−RE), where CO is a sensed fluid capacitance level when there is no fluid present, CL is the sensed fluid capacitance level, RL is the wet reference capacitance value, and RE is the dry reference capacitance value. Additionally, shielding the trace 216 from capacitive interference may be performed via a wet reference shield 218. In such an example, the wet reference shield may be electrically driven.

In operation, the fluid level sensor 200 may be adhered to an exterior of a vessel for fluid measurement. In such an example, the fluid level sensor 200 may be flexed to conform to contours of an exterior of a vessel being measured and/or to the contours of a tube containing the fluid level sensor 200.

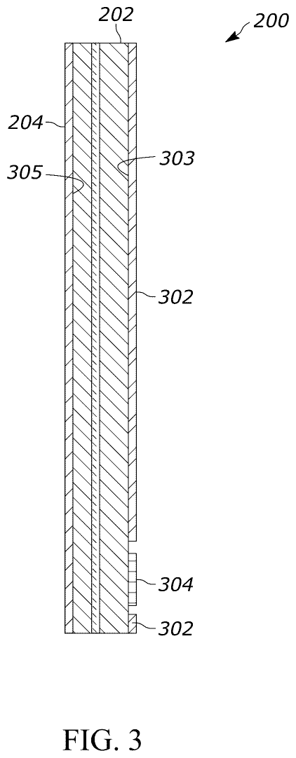

FIG. 3 depicts a cross sectional view of the fluid level sensor 200 embodiment of the present invention as it would be applied to a ridged or flexible substrate 202. As illustrated, fluid level sensor 200 is implemented as a multi-layer PCB including an additional exterior shielding layer 302 positioned about a capacitance to digital converter 304.

In some implementations, the fluid level sensor 200 includes the exterior shielding layer 302 which is located on an outer surface 303 of the substrate 202 that is opposite an inner surface 305 of the substrate 202 where the continuous sensor plate 204 is located. In some examples, the exterior shielding layer 302 is composed of copper, another flexible conductive substance, and/or combinations thereof.

In some examples, the fluid level sensor 200 includes the capacitance to digital converter 304 used, as known in the art, to convert measured capacitances to digitally represented values that may be processed by a suitable processing device. In such an example, the capacitance to digital converter 304 is located on the outer surface 303 of the substrate 202 in a gap formed in the exterior shielding layer 302. It is noted that electrical connections between the various conductors of the sensors 100, 200 and the capacitance to digital converter 304, or electrical connections between the capacitance to digital converter 304 and a data processor, are not shown for ease of illustration. Techniques for the establishment of such connections are well known to those skilled in the art.

In operation, the continuous sensor plate, the wet reference capacitive plate, and the dry reference capacitive plate are shielded from capacitive interference via the exterior shielding layer 302. Such shielding via the exterior shielding layer 302 prevents interference with a user (e.g., a user's hand).

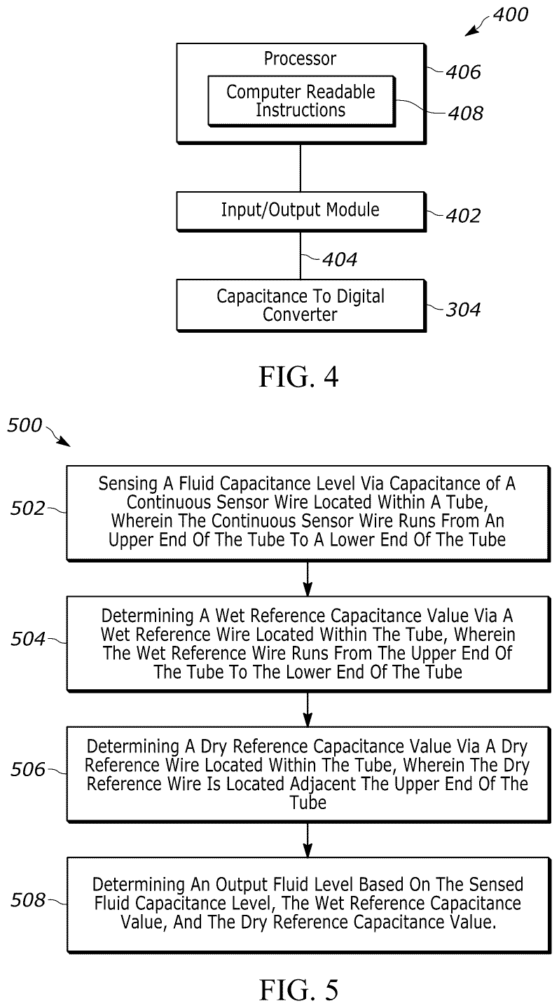

FIG. 4 illustrates a schematic view of a data processor 400 according to an example of the instant disclosure. As illustrated data processor 400 includes a capacitance to digital converter 304 coupled to an input/output (I/O) module 402 via an interconnect 404. Data from the I/O module 402 may be processed by computer readable instructions 408 associated with a processor 406. In some examples computer readable instructions 408 may be implemented via hardware, firmware, software, and/or combinations thereof.

In operation, the data processor 400 receives capacitance levels from the continuous sensor wire, the wet reference wire, and the dry reference wire. These capacitance levels are converted to digital values by the capacitance to digital converter 304 for use by the I/O module 402. These digital values are eventually processed according to computer readable instructions 408 via the processor 406.

FIG. 5 is a flowchart of an example of a method 500 for fluid level sensing according to an example. The method 500 may generally be implemented in an apparatus, such as, for example, the fluid level sensor 100 (FIG. 1), already discussed.

In an example, the method 500 can be implemented in computer readable instructions (e.g., software), configurable computer readable instructions (e.g., firmware), fixed-functionality computer readable instructions (e.g., hardware), etc., or any combination thereof.

It will be appreciated that some or all of the operations the method 500 are described using a “pull” architecture (e.g., polling for new information followed by a corresponding response) can instead be implemented using a “push” architecture (e.g., sending such information when there is new information to report), and vice versa.

Illustrated processing block 502 provides for sensing a fluid capacitance value via a continuous sensor wire. For example, a fluid-related capacitance value is sensed via a continuous sensor wire located within a tube, where the continuous sensor wire runs from an upper end of the tube to a lower end of the tube as described above.

Illustrated processing block 504 provides for determining a wet reference capacitance value. For example, a wet reference capacitance value is determined via a wet reference wire located within the tube, where the wet reference wire runs from the upper end of the tube to the lower end of the tube as described above.

Illustrated processing block 506 provides for determining a dry reference capacitance value. For example, a dry reference capacitance value is determined via a dry reference wire located within the tube, where the dry reference wire is located adjacent the upper end of the tube as described above.

Illustrated processing block 508 provides for determining an output fluid level. For example, an output fluid level is determined based on the sensed fluid capacitance value, the wet reference capacitance value, and the dry reference capacitance value as described above.

In some examples, method 500 further includes shielding, via a wet reference shield sheath, a first covered portion of the wet reference wire so as to leave a second exposed portion of the wet reference wire uncovered from the wet reference shield sheath, where the second exposed portion of the wet reference wire is adjacent the lower end of the tube. In such an example, the wet reference shield sheath may be electrically driven.

In some implementations, method 500 further includes shielding, via a dry reference shield sheath, a first covered portion of the dry reference wire so as to leave a second exposed portion of the dry reference wire uncovered from the dry reference shield sheath. In such an example, the dry reference shield sheath may be electrically driven.

Another method (not illustrated here) may generally be implemented in an apparatus, such as, for example, the fluid level sensor 200 (FIG. 2), already discussed. Such a method includes sensing a fluid capacitance value via a continuous sensor plate of a fluid level sensor, wherein the sensor plate runs from an upper end of a substrate to a lower end of the substrate. A wet reference capacitance value is determined via a wet reference capacitive plate located adjacent the lower end of the substrate. A dry reference capacitance value is determined via a dry reference capacitive plate located adjacent the upper end of the substrate. An output fluid level is determined based on the sensed fluid capacitance value, the wet reference capacitance value, and the dry reference capacitance value. A trace is shielded from capacitive interference via a wet reference shield, where the trace and the wet reference shield run from the upper end of the substrate to the wet reference capacitive plate.

In some examples, the wet reference shield is electrically driven.

In some implementations, the continuous sensor plate, the wet reference capacitive plate, and the dry reference capacitive plate are shielded from capacitive interference via an exterior shielding layer, where the exterior shielding layer is located on an outer surface of the substrate that is opposite an inner surface of the substrate where the continuous sensor plate is located.

In some examples, the fluid level sensor is adhered to an exterior of a vessel. In some implementations, the fluid level sensor is flexed to conform to the exterior of the vessel.

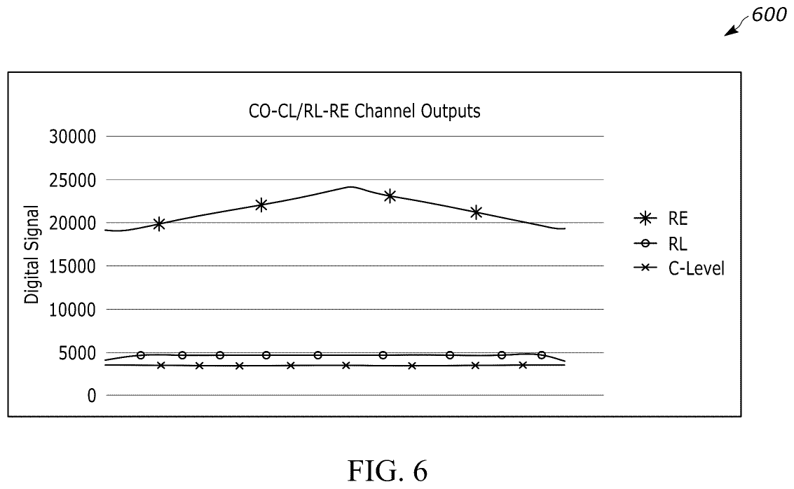

FIG. 6 depicts the results 600 of a simulation in order to further explain the operation of embodiments of the present invention. A simulation was carried out in which a vessel was filled with water and then drained. The x-axis (not shown) indicates the level in the vessel, and the y-axis indicates the sensed values (digitized by a digitizer, not shown). The sensed capacitance level (C-LEVEL) rises and falls with the fluid level as the vessel is filled and then drained. RE, being the environmental reference, does not change because no media contacts it and there was no observed change in any environmental factor, e.g., temperature. RL, being the liquid reference, experiences a rise and then drop as it initially comes into and then loses contact with the media but is otherwise stable. RE and RL work in unison. RL operates to compensate the wetted portion of C-LEVEL should the media experience a change in dielectric (e.g., either due to physically changing the media in the vessel or the temperature) and RE operates to compensate the un-wetted portion of C-LEVEL that may be influenced by changing environmental conditions in the vessel.

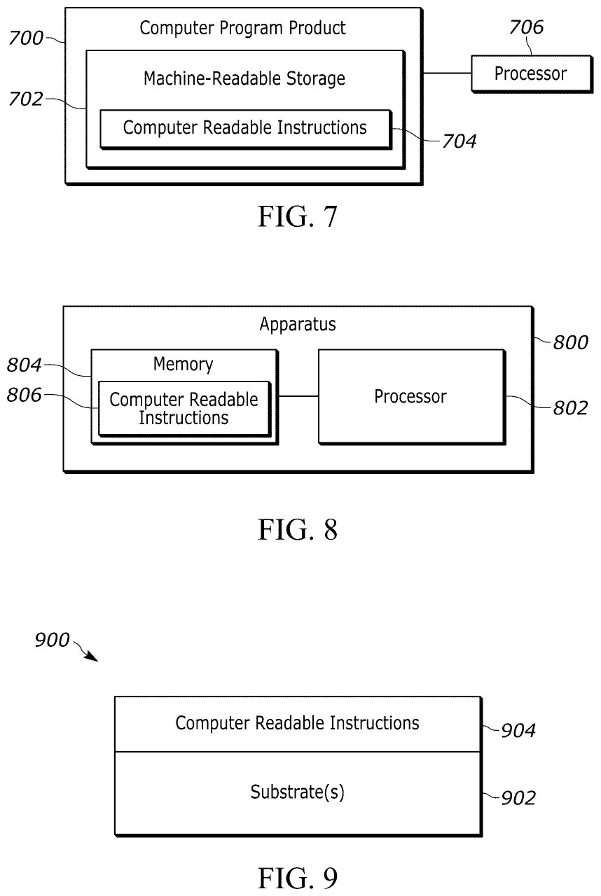

FIG. 7 illustrates a block diagram of an example computer program product 700. In some examples, as shown in FIG. 7, computer program product 700 includes a machine-readable storage 702 that can also include computer readable instructions 704. In some implementations, the machine-readable storage 702 can be implemented as a non-transitory machine-readable storage. In some implementations the computer readable instructions 704, which can be implemented as software, for example. In an example, the computer readable instructions 704, when executed by a processor 706, implement one or more aspects of the method 500 (FIG. 5), already discussed.

FIG. 8 shows an illustrative example of an apparatus 800. In the illustrated example, the apparatus 800 can include a processor 802 and a memory 804 communicatively coupled to the processor 802. The memory 804 can include computer readable instructions 806, which can be implemented as software, for example. In an example, the computer readable instructions 806, when executed by the processor 802, implement one or more aspects of the method 500 (FIG. 5), already discussed.

In some implementations, the processor 802 can include a general purpose controller, a special purpose controller, a storage controller, a storage manager, a memory controller, a micro-controller, a general purpose processor, a special purpose processor, a central processor unit (CPU), the like, and/or combinations thereof.

Further, implementations can include distributed processing, component/object distributed processing, parallel processing, the like, and/or combinations thereof. For example, virtual computer system processing can implement one or more of the methods or functionalities as described herein, and the processor 802 described herein can be used to support such virtual processing.

In some examples, the memory 804 is an example of a computer-readable storage medium. For example, memory 804 can be any memory which is accessible to the processor 802, including, but not limited to RAM memory, registers, and register files, the like, and/or combinations thereof. References to “computer memory” or “memory” should be interpreted as possibly being multiple memories. The memory can for instance be multiple memories within the same computer system. The memory can also be multiple memories distributed amongst multiple computer systems or computing devices.

FIG. 9 shows an illustrative semiconductor apparatus 900 (e.g., chip and/or package). The illustrated apparatus 900 includes one or more substrates 902 (e.g., silicon, sapphire, or gallium arsenide) and computer readable instructions 904 (such as, configurable computer readable instructions (e.g., firmware) and/or fixed-functionality computer readable instructions (e.g., hardware)) coupled to the substrate(s) 902. In an example, the computer readable instructions 904 implement one or more aspects of the method 500 (FIG. 5), already discussed.

In some implementations, computer readable instructions 904 can include transistor array and/or other integrated circuit (IC) components. For example, configurable firmware logic and/or fixed-functionality hardware logic implementations of the computer readable instructions 904 can include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

### ADDITIONAL NOTES AND EXAMPLES

Clause 1 is a fluid level sensor, comprising: a tube; a continuous sensor wire located within the tube, wherein the continuous sensor wire runs from an upper end of the tube to a lower end of the tube; a ground wire located within the tube, wherein the ground wire runs from the upper end of the tube to the lower end of the tube; a wet reference wire located within the tube, wherein the wet reference wire runs from the upper end of the tube to the lower end of the tube; and a dry reference wire located within the tube, wherein the dry reference wire is located adjacent the upper end of the tube.

Clause 2 includes the fluid level sensor of Clause 1, further comprising a wet reference shield sheath located on a first covered portion of the wet reference wire so as to leave a second exposed portion of the wet reference wire uncovered from the wet reference shield sheath, and wherein the second exposed portion of the wet reference wire is adjacent the lower end of the tube.

Clause 3 includes the fluid level sensor of Clause 2, wherein the wet reference shield sheath is electrically driven.

Clause 4 includes the fluid level sensor of any one of Clauses 1 to 3, further comprising a dry reference shield sheath located on a first covered portion of the dry reference wire so as to leave a second exposed portion of the dry reference wire uncovered from the dry reference shield sheath.

Clause 5 includes the fluid level sensor of Clause 4, wherein the dry reference shield sheath is electrically driven.

Clause 6 includes the fluid level sensor of any one of Clauses 1 to 5, wherein the continuous sensor wire, the ground wire, the wet reference wire, and the dry reference wire are all flexible.

Clause 7 includes the fluid level sensor of any one of Clauses 1 to 6, wherein the continuous sensor wire, the ground wire, the wet reference wire, and the dry reference wire are all coated with a wire jacket to electrically isolate each wire.

Clause 8 includes a fluid level sensor, comprising: a substrate; a continuous sensor plate located on the substrate, wherein the continuous sensor plate runs from an upper end of the substrate to a lower end of the substrate; a continuous ground plate located on the substrate, wherein the continuous ground plate runs from the upper end of the substrate to the lower end of the substrate; a wet reference capacitive plate located on the substrate, wherein the wet reference capacitive plate is located adjacent the lower end of the substrate; and a dry reference capacitive plate located on the substrate, wherein the dry reference capacitive plate is located adjacent the upper end of the substrate.

Clause 9 includes the fluid level sensor of Clause 8, wherein the substrate is flexible.

Clause 10 includes the fluid level sensor of any one of Clauses 8 to 9, wherein the substrate is rigid.

Clause 11 includes the fluid level sensor of any one of Clauses 8 to 10, further comprising: a trace running from the upper end of the substrate to the wet reference capacitive plate; and a wet reference shield located adjacent the trace, wherein the wet reference shield runs from the upper end of the substrate to the wet reference capacitive plate.

Clause 12 includes the fluid level sensor of Clause 11, wherein the wet reference shield is electrically driven.

Clause 13 includes the fluid level sensor of any one of Clauses 8 to 12, further comprising an exterior shielding layer located on an outer surface of the substrate that is opposite an inner surface of the substrate where the continuous sensor plate is located, and wherein the exterior shielding layer is composed of copper.

Clause 14 includes the fluid level sensor of Clause 13, further comprising a capacitance to digital converter located on the outer surface of the substrate in a gap formed in the exterior shielding layer.

Clause 15 includes the fluid level sensor of any one of Clauses 8 to 14, further comprising a tube located around the fluid level sensor.

Clause 16 includes a method comprising: sensing a fluid capacitance level via a continuous sensor wire located within a tube, wherein the continuous sensor wire runs from an upper end of the tube to a lower end of the tube; determining a wet reference capacitance value via a wet reference wire located within the tube, wherein the wet reference wire runs from the upper end of the tube to the lower end of the tube; determining a dry reference capacitance value via a dry reference wire located within the tube, wherein the dry reference wire is located adjacent the upper end of the tube; and determining an output fluid level based on the sensed fluid capacitance level, the wet reference capacitance value, and the dry reference capacitance value.

Clause 17 includes the method of Clause 16, further comprising shielding, via a wet reference shield sheath, a first covered portion of the wet reference wire so as to leave a second exposed portion of the wet reference wire uncovered from the wet reference shield sheath, and wherein the second exposed portion of the wet reference wire is adjacent the lower end of the tube.

Clause 18 includes the method of Clause 17, wherein the wet reference shield sheath is electrically driven.

Clause 19 includes the method of any one of Clauses 16 to 18, further comprising shielding, via a dry reference shield sheath, a first covered portion of the dry reference wire so as to leave a second exposed portion of the dry reference wire uncovered from the dry reference shield sheath.

Clause 20 includes the method of Clause 19, wherein the dry reference shield sheath is electrically driven.

Clause 21 includes a method comprising: sensing a fluid level via a continuous sensor plate of a fluid level sensor, wherein the sensor plate runs from an upper end of a substrate to a lower end of the substrate; determining a wet reference value via a wet reference capacitive plate located adjacent the lower end of the substrate; determining a dry reference value via a dry reference capacitive plate located adjacent the upper end of the substrate; determining an output fluid level based on the sensed fluid level, the wet reference value, and the dry reference value; and shielding a trace from capacitive interference via a wet reference shield, wherein the trace and the wet reference shield run from the upper end of the substrate to the wet reference capacitive plate.

Clause 22 includes the method of Clause 21, wherein the wet reference shield is electrically driven.

Clause 23 includes the method of any one of Clauses 21 to 22, further comprising shielding the continuous sensor plate, the wet reference capacitive plate, and the dry reference capacitive plate from capacitive interference via an exterior shielding layer, wherein the exterior shielding layer is located on an outer surface of the substrate that is opposite an inner surface of the flexible substrate where the continuous sensor plate is located.

Clause 24 includes the method of any one of Clauses 21 to 23, further comprising adhering the fluid level sensor to an exterior of a vessel.

Clause 25 includes the method of Clause 24, further comprising flexing the fluid level sensor to conform to the exterior of the vessel.

Clause 26 includes a machine-readable storage including machine-readable instructions, which when executed, implement a method or realize an apparatus as claimed in any preceding Clause.

Clause 27 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. A fluid level sensor, comprising:
a tube;
a continuous sensor wire located within the tube, wherein the continuous sensor wire runs from an upper end of the tube to a lower end of the tube;
a ground wire located within the tube, wherein the ground wire runs from the upper end of the tube to the lower end of the tube;
a wet reference wire located within the tube, wherein the wet reference wire runs from the upper end of the tube to the lower end of the tube; and
a dry reference wire located within the tube, wherein the dry reference wire is located adjacent the upper end of the tube.

2. The fluid level sensor of claim 1, further comprising a wet reference shield sheath located on a first covered portion of the wet reference wire so as to leave a second exposed portion of the wet reference wire uncovered from the wet reference shield sheath, and wherein the second exposed portion of the wet reference wire is adjacent the lower end of the tube.

3. The fluid level sensor of claim 2, wherein the wet reference shield sheath is electrically driven.

4. The fluid level sensor of claim 1, further comprising a dry reference shield sheath located on a first covered portion of the dry reference wire so as to leave a second exposed portion of the dry reference wire uncovered from the dry reference shield sheath.

5. The fluid level sensor of claim 4, wherein the dry reference shield sheath is electrically driven.

6. The fluid level sensor of claim 1, wherein the continuous sensor wire, the ground wire, the wet reference wire, and the dry reference wire are all flexible.

7. The fluid level sensor of claim 1, wherein the continuous sensor wire, the ground wire, the wet reference wire, and the dry reference wire are all coated with a wire jacket to electrically isolate each wire.

8. A fluid level sensor, comprising:
a substrate;
a continuous sensor plate located on the substrate, wherein the continuous sensor plate runs from an upper end of the substrate to a lower end of the substrate;
a continuous ground plate located on the substrate, wherein the continuous ground plate runs from the upper end of the substrate to the lower end of the substrate;
a wet reference capacitive plate located on the substrate, wherein the wet reference capacitive plate is located adjacent the lower end of the substrate; and
a dry reference capacitive plate located on the substrate, wherein the dry reference capacitive plate is located adjacent the upper end of the substrate.

9. The fluid level sensor of claim 8, wherein the substrate is flexible.

10. The fluid level sensor of claim 8, wherein the substrate is rigid.

11. The fluid level sensor of claim 8, further comprising:
a trace running from the upper end of the substrate to the wet reference capacitive plate; and
a wet reference shield located adjacent the trace, wherein the wet reference shield runs from the upper end of the substrate to the wet reference capacitive plate.

12. The fluid level sensor of claim 11, wherein the wet reference shield is electrically driven.

13. The fluid level sensor of claim 8, further comprising an exterior shielding layer located on an outer surface of the substrate that is opposite an inner surface of the substrate where the continuous sensor plate is located, and wherein the exterior shielding layer is composed of copper.

14. The fluid level sensor of claim 13, further comprising a capacitance to digital converter located on the outer surface of the substrate in a gap formed in the exterior shielding layer.

15. The fluid level sensor of claim 8, further comprising a tube located around the fluid level sensor.

16. A method comprising:
sensing a fluid capacitance level via a continuous sensor wire located within a tube, wherein the continuous sensor wire runs from an upper end of the tube to a lower end of the tube;
determining a wet reference capacitance value via a wet reference wire located within the tube, wherein the wet reference wire runs from the upper end of the tube to the lower end of the tube;
determining a dry reference capacitance value via a dry reference wire located within the tube, wherein the dry reference wire is located adjacent the upper end of the tube; and
determining an output fluid level based on the sensed fluid capacitance level, the wet reference capacitance value, and the dry reference capacitance value.

17. The method of claim 16, further comprising shielding, via a wet reference shield sheath, a first covered portion of the wet reference wire so as to leave a second exposed portion of the wet reference wire uncovered from the wet reference shield sheath, and wherein the second exposed portion of the wet reference wire is adjacent the lower end of the tube.

18. The method of claim 17, wherein the wet reference shield sheath is electrically driven.

19. The method of claim 16, further comprising shielding, via a dry reference shield sheath, a first covered portion of the dry reference wire so as to leave a second exposed portion of the dry reference wire uncovered from the dry reference shield sheath.

20. The method of claim 19, wherein the dry reference shield sheath is electrically driven.
